(19) United States
(12) Patent Application Publication
(10) Pub. No.: US 2022/0018997 A1
(43) Pub. Date: Jan. 20, 2022

(54) Optical Imaging Lens Assembly and Display Device

(71) Applicant: ZHEJIANG SUNNY OPTICS CO.,LTD., Ningbo (CN)

(72) Inventors: Kaikai ZHANG, Ningbo (CN); Libang CHENG, Ningbo (CN); Li CHEN, Ningbo (CN); Xiancui DING, Ningbo (CN); Jianjun LI, Ningbo (CN); Fujian DAI, Ningbo (CN); Liefeng ZHAO, Ningbo (CN)

(21) Appl. No.: 17/170,921

(22) Filed: Feb. 9, 2021

(30) Foreign Application Priority Data
Jul. 20, 2020 (CN) 202021432850.6

(51) Int. Cl. G02B 5/00; G02B 7/02

(52) U.S. Cl. CPC G02B 5/003; G02B 7/021

(57) ABSTRACT

Some embodiments of the disclosure provide an optical imaging lens assembly and a display device. The optical imaging lens assembly includes: a lens barrel, a lens, and a microstructure. The lens barrel has a body and a mount hole disposed on the body; the lens is disposed in the mount hole; and an outer wall surface of the body and/or an inner wall surface of the mount hole is provided with the microstructure.

### CROSS-REFERENCE TO RELATED APPLICATION(S)

The disclosure claims priority to Chinese Patent Application No. 202021432850.6, filed on Jul. 20, 2020 and entitled “Optical Imaging Lens Assembly and Display Device”, the disclosure of which is hereby incorporated by reference in its entirety.

### TECHNICAL FIELD

The disclosure relates to a technical field of optical imaging lens, in particular to an optical imaging lens assembly and a display device.

### BACKGROUND

With a rapid development of smart phones, various technologies in a mobile phone industry have been gradually developed in a more stable, mature and lower cost direction. Since mobile phone lenses are the key part for achieving photographing functions of mobile phones, their surface blackness and light extinction performance have attracted much attention of major manufacturers and consumers.

In a type of imaging camera lenses known to the inventor, the surface blackness and light extinction performance of the lenses are generally improved by coating lens barrels of the lenses, which is a processing method needing high cost.

### SUMMARY

Some embodiments provide an optical imaging lens assembly and a display device, to achieve good blackness and light extinction performance of the imaging lens assembly at a lower cost.

In some embodiments, an optical imaging lens assembly is provided. The optical imaging lens assembly includes: a lens barrel, a lens, and a microstructure. The lens barrel has a body and a mount hole; the lens is disposed in the mount hole; and an outer wall surface of the body and/or an inner wall surface of the mount hole is provided with the microstructure.

In some embodiments, when the outer wall surface of the body is provided with the microstructure, the body includes an outer periphery surface, a first end face, and a second end face opposite the first end face. Both the first end face and the second end face are connected with the outer periphery surface. The first end face is provided with the microstructure, or the second end face is provided with the microstructure, or both the first end face and the second end face are provided with the microstructures respectively.

In some embodiments, when the inner wall surface of the mount hole is provided with the microstructure, the microstructure is located in an area, which is not in contact with the lens, of the mount hole.

In some embodiments, when the microstructure is disposed on the outer surface of the body, the optical imaging lens assembly includes a plurality of microstructures that are sequentially arranged around a center axis of the mount hole, from a center of the body to an outside of the body; or when the microstructure is disposed on the inner wall surface of the mount hole, the optical imaging lens assembly includes a plurality of microstructures that are sequentially arranged along an axial direction of the body.

In some embodiments, the microstructure extends along a circumference of the mount hole to form a ring structure.

In some embodiments, the microstructure includes a convex rib or a spiral groove.

In some embodiments, when the microstructure includes the convex rib, a cross section of the convex rib is shaped as a triangle, a rectangle, or a trapezoid.

In some embodiments, when the microstructure includes the convex rib, the optical imaging lens assembly includes a plurality of microstructures, a groove is formed between every two adjacent microstructures in the plurality of microstructures, and the groove is a curved groove, a rectangular groove, or a triangular groove.

In some embodiments, a height H of the microstructure satisfies a following condition: 0<H≤0.4 mm; or, an included angle B of the microstructure satisfies a following condition: 0<B<180; or when a plurality of microstructures are provided, an interval L between every two adjacent microstructures in the plurality of microstructures satisfies a following condition: 0<L≤0.2 mm.

Some embodiments of the present disclosure provide a display device. The display device includes the above optical imaging lens assembly, By applying the technical solution of some embodiments of the disclosure, a microstructure is disposed on an outer wall surface of a body and/or an inner wall surface of a mount hole, of a lens barrel. When light is emitted into the lens barrel, by using the microstructure disposed on the surface of the lens barrel, on the one hand, a part of the light is absorbed, so that the surface blackness of the lens barrel is improved, and on the other hand, light irradiated to a lens is decomposed to be reflected or refracted to multiple directions, so that brightness of the light is reduced and the light extinction performance of the lens barrel is improved. Therefore, the surface blackness and light extinction performance of the lens assembly are improved through the microstructure disposed on the surface of the lens barrel, so as to improve imaging quality. Compared with a coating process, the microstructure in the present disclosure has simple production steps and low cost.

### BRIEF DESCRIPTION OF THE DRAWINGS

Drawings of the description for constituting a part of the present disclosure are used to provide further understanding of the disclosure, and exemplary embodiments of the disclosure and descriptions thereof are used to explain the disclosure, and do not constitute improper limitation to the disclosure. In the drawings:

FIG. 1 shows a schematic structural diagram of a lens barrel of an optical imaging lens assembly according to an embodiment of the disclosure; and

FIG. 2 shows a view A-A of FIG. 1

Herein, the above drawings include the following reference signs:
10, Lens barrel; 11, body; 111, first end face; 12, mount hole; and 20, microstructure.

### DETAILED DESCRIPTION OF THE EMBODIMENTS

It is to be noted that, the embodiments in the present disclosure and characteristics in the embodiments may be combined under the condition of no conflicts. The disclosure is described below with reference to the drawings and in conjunction with the embodiments in detail.

It is to be noted that, all technical and scientific terms used herein have the same meaning as commonly understood by those of ordinary skill in the art to which the present disclosure belongs, unless otherwise indicated.

In the disclosure, if there is no explanation to the contrary, the orientation words used such as “up, down, top, and bottom” are usually for the direction shown in the drawings, or for the vertical, perpendicular or gravitational direction of each component itself. Similarly, for ease of understanding and description, “inner and outer” refers to the inner and outer parts relative to the contour of each component itself, but the abovementioned orientation words are not used to limit the disclosure.

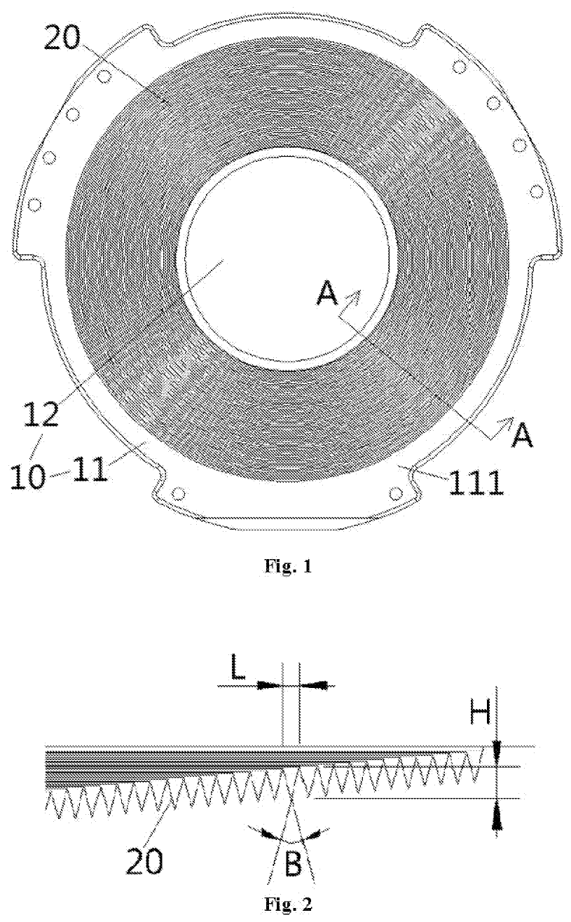

As shown in FIG. 1, in some embodiments of the disclosure, the optical imaging lens assembly includes: a lens barrel 10, a lens, and a microstructure 20. The lens barrel 10 has a body and a mount hole 12 disposed on the body 11; the lens is disposed in the mount hole 12; and an outer wall surface of the body 11 and/or an inner wall surface of the mount hole 12 is provided with the microstructure 20.

In the above arrangement, the microstructure 20 is disposed on the outer wall surface of the body 11 and/or the inner wall surface of the mount hole 12, of the lens barrel 10. When light is irradiated into the lens barrel 10, by using the microstructure 20 disposed on the surface of the lens barrel 10, on the one hand, a part of the light is absorbed, so that surface blackness of the lens barrel 10 is improved, and on the other hand, light irradiated to the lens is decomposed to be reflected or refracted to multiple directions, so that brightness of light is reduced and light extinction performance of the lens barrel 10 is improved. Therefore, the surface blackness and light extinction performance of the camera lens are improved through the microstructure disposed on the surface of the lens barrel 10, so as to improve imaging quality. Compared with a coating process, the microstructure in some embodiments of the present disclosure has simple production steps and low cost.

As shown in FIG. 1 and FIG. 2, in some embodiments of the disclosure, when the outer wall surface of the body 11 is provided with the microstructure 20, the body 11 includes an outer periphery surface, a first end face 111, and a second end face opposite the first end face 111. Both the first end face 111 and the second end face are connected with the outer periphery surface, wherein only the first end face 111 is provided with the microstructure 20.

In the above arrangement, the first end face 111 of the body 11 is provided with the microstructure 20; through the microstructure 20, a part of light irradiated to the fist end face 111 can be absorbed, so that the blackness of the first end face 111 is increased; a part of light irritated to the first end face 111 may also be reflected or refracted so that the light extinction performance of the first end face 111 is improved. Therefore, the microstructure 20 disposed on the first end face 111 improves the surface blackness and light extinction performance of the first end face 111, to improve the imaging quality.

In alternative embodiments not shown in the drawings of the present disclosure, according to actual needs, only the second end face is provided with the microstructure 20; or both the first end face 111 and the second end face are provided with the microstructures 20 respectively.

In other embodiments of the present disclosure, an inner wall surface of a mount hole 12 is provided with a microstructure 20. Thus, the microstructure 20 can absorb, reflect, or refract a part of light passing through the mount hole, and accordingly improves the surface blackness and light extinction performance of the inner wall surface of the mount hole 12.

In some embodiments, when the inner wall surface of the mount hole 12 is provided with the microstructure 20, the microstructure 20 is located in an area, which is not in contact with the lens, of the mount hole 12, to ensure that the lens is successfully mounted in the mount hole 12 of the lens barrel 10, and the area, which is not in contact with the lens, of the lens barrel 10 has high blackness and light extinction performance.

As shown in FIG. 1 and FIG. 2, in some embodiments of the disclosure, the microstructure 20 is disposed on the outer surface of the body 11, the optical imaging lens assembly includes a plurality of microstructures 20, the plurality of microstructures 20 are sequentially arranged around a center axis of the mount hole 12, from a center of the body 11 to an outside thereof.

In the above arrangement, the plurality of microstructures 20 are sequentially arranged around the center axis of the mount hole 12, on the one hand, light absorption degree of the microstructures 20 is increased to improve the blackness of the outer surface of the body 11, and on the other hand, light decomposition degree of the microstructures 20 is improved, the microstructures 20 have higher light reflection or refraction action, so that the brightness of light is further reduced, and the light extinction performance of the lens barrel 10 is improved. Therefore, through the above arrangement, the lens assembly has better surface blackness and light extinction performance.

In some embodiments, the plurality of microstructures 20 are arranged at intervals on the surface of the body 11. In some embodiments, the plurality of microstructures 20 are evenly or unevenly arranged at intervals. The above-mentioned different arrangement modes may be selected according to actual conditions.

In other embodiments of the present disclosure, an interval between adjacent microstructures 20 of the plurality of microstructures 20 may be zero according to actual needs, that is to say, two adjacent microstructures 20 are in contact and connected with each other.

In alternative embodiments not shown in the drawings of the present disclosure, when the microstructure 20 is located on the inner wall surface of the mount hole 12, the optical imaging lens assembly includes a plurality of microstructures 20 that are sequentially arranged along an axial direction of the body 11.

As shown in FIG. 1, in some embodiments of the disclosure, the microstructure 20 extends along a circumference of the mount hole 12, to form a ring structure. By the above arrangement, the microstructure 20 has a better effect in improving the surface blackness and light extinction performance of the c lens assembly.

It is to be noted that the above ring structure may be a circular ring structure, and may also be a circular arc structure.

In some embodiments of the present disclosure, according to actual needs, the microstructure 20 may be configured to be rectangular, oval, or the like according to actual needs.

As shown in FIG. 2, in some embodiments of the disclosure, the microstructure 20 includes a convex rib. This arrangement facilitates processing.

In some embodiments not shown in the drawings of the present disclosure, according to actual needs, the microstructure 20 may be configured to be a grooved structure; preferably, the grooved structure may be a spiral groove or an angular groove according to actual needs.

As shown in FIG. 2, in some embodiments of the disclosure, a cross section of the convex rib is triangular. This arrangement facilitates the processing on the one hand, and on the other hand, the microstructure 20 has a large contact area with light, it is beneficial for light absorption, reflection, or refraction through the microstructure 20, thereby improving the surface blackness and light extinction performance of the camera lens by the microstructure 20.

In alternative embodiments not shown in the drawings of the present disclosure, according to actual needs, the cross section of the convex rib may be of rectangular or trapezoidal or arc-shaped.

In alternative embodiments not shown in the drawings of the present disclosure, when the microstructure 20 is a grooved structure, the cross section of the grooved structure may be configured into an arc, or an oval, or other shapes.

It is to be noted that the cross section refers to a section that is parallel to the center axis of the mount hole 12.

As shown in FIG. 2, in some embodiments of the disclosure, the microstructure 20 includes a convex rib, the optical imaging camera lens includes a plurality of microstructures 20, a groove is formed between two microstructures 20 corresponding thereto, and the groove is a triangular groove.

In the above arrangement, since the groove formed between two adjacent microstructures 20 is the triangular groove, the processing is facilitated on the one hand, and on the other hand, the microstructure 20 has a large contact area with the light, which facilitates light absorption, reflection, or refraction by the microstructure 20, so that the effect of the microstructure 20 in improving the surface blackness and light extinction performance of the camera lens is improved.

In some embodiments of the present disclosure, according to actual needs, the groove may be arranged as an arc-shaped groove, a rectangular groove, a trapezoidal groove, or a groove in other shapes; in some embodiments, a range of size of the groove is greater than 0 mm and not greater than 0.2 mm.

As shown in FIG. 2, in some embodiments of the disclosure, a height H of the microstructure 20 satisfies the following condition: 0<H≤0.4 mm; an included angle B of the microstructure satisfies the following condition: 0<B<180; an interval L between every two adjacent microstructures 20 of the plurality of microstructures 20 satisfies the following condition: 0<L≤0.2 mm.

In the above arrangement, when H is greater than 0.4 mm, the height of the microstructure 20 is over high while the strength is low, the microstructure 20 is easy to deform in a forming process and an assembling process of the lens assembly, which is unfavorable for light reflection or refraction of the microstructure 20 and affects the light extinction effect of the microstructure 20; when L is greater than 0.2 mm, the distance between every two adjacent structures 20 is too large, which makes the effect of light absorption, reflection, or refraction by the microstructure 20 poor, so that the effect of the microstructure 20 in improving the surface blackness and light extinction performance of the lens assembly is poor; when 0<H≤0.4 mm, 0<B<180°, and 0<L≤0.2 mm, the microstructure 20 has a good light absorption effect to improve the surface blackness of the lens assembly, besides, the microstructure 20 has high light decomposition degree, that is to say, the microstructure 20 may reflect or refract the light to multiple directions, so that the brightness of the light is reduced, and the light extinction performance of the lens assembly is improved; in addition, the microstructure 20 has high strength, is not easy to deform in the forming process and in the assembling process of the lens assembly, is stable in structure, and accordingly is ensured to have a good extinction effect.

In some embodiments not shown in the drawings of the present disclosure, according to actual needs, only the height H of the microstructure 20 satisfies the following condition: 0<H≤0.4 mm; or only the included angle B of the microstructure 20 satisfies the following condition: 0<B<180; or only the interval L between two adjacent microstructures 20 of the plurality of microstructures 20 satisfies the following condition: 0<L≤0.2 mm; or any two of the above three conditions are satisfied.

Some embodiments of the disclosure further provide a display device. The display device includes a display panel and the above-mentioned optical imaging lens assembly, wherein the optical imaging lens assembly is disposed on the display panel.

In the technical solution of the present disclosure, the display device includes the optical imaging lens assembly of the present disclosure, the display device has the above-mentioned advantages of the optical imaging lens assembly, which will not be elaborated herein.

In some embodiments, the display device may be any product or component having a display function, such as a liquid crystal panel, a cellphone, a tablet personal computer, a display, a television, and a notebook computer.

The embodiment of the present disclosure is described below in conjunction with FIG. 1 and FIG. 2.

As shown in FIG. 1, a plurality of microstructures 20 are disposed on a first end face 111 of a body 11 of a lens barrel 10. Each of the plurality of microstructures 20 includes a convex rib, the convex rib is arranged around a center axis of a mount hole 12 and encircles to form a circular ring structure. From a radial center of the body 11 to a radial outside thereof, a radial dimension of the circular ring structure formed by the convex rib is gradually increased. Through the above arrangement, the plurality of microstructures 20 absorb a part of light, so that the surface blackness of the lens barrel 10 is improved, and on the other hand, the microstructures 20 decompose the light irradiated to the lens from different areas, the light is reflected or refracted to multiple directions, so that the brightness of the light is reduced and the light extinction performance of the lens barrel 10 is improved. Therefore, the surface blackness and light extinction performance of the camera lens are improved through the microstructures disposed on the surface of the lens barrel 10, so as to improve the imaging quality.

In some embodiments, the microstructure 20 is in symmetrical arrangement relative to the center axis of the mount hole 12. In some embodiments, the microstructure 20 may be not in symmetrical arrangement relative to the center axis of the mount hole 12.

As shown in FIG. 2, in some embodiments, the convex rib is a triangular rib, where a height H of the convex rib of the microstructure 20 satisfies the following condition: 0<H≤0.4 mm; an included angle B of the convex rib satisfies the following condition: 0<B<180 an interval L between every two adjacent convex ribs satisfies the following condition: 0<L≤0.2 mm.

In summary of the above arrangement, the microstructures 20 have a good light absorption effect, so as to improve the surface blackness of the lens assembly, and the degree of decomposition of the microstructures 20 on the light is high, that is, the microstructures 20 may reflect or refract the light to multiple directions, so that the brightness of the light is reduced, and the light extinction performance of the lens assembly is improved. According to the technical solution of the embodiments of the present disclosure, based on a forming process of the lens assembly, annular, spiral or other shaped microstructures, which are symmetrical around the optical axis, are arranged on the lens assembly, and are used to decompose the light irradiated to the lens assembly, thereby achieving the purpose of improving the surface blackness and light extinction performance of the lens assembly.

It can be seen from the above descriptions, the above-mentioned embodiments of the disclosure achieve the following technical effects: the microstructure is disposed on the outer wall surface of the body and/or the inner wall surface of the mount hole, of the lens barrel; when the light is irradiated into the lens barrel, by using the microstructure disposed on the surface of the lens barrel, on the one hand, a part of the light is absorbed so that the surface blackness of the lens barrel is improved, and on the other hand, the light irradiated to the lens is decomposed, the light is reflected or refracted to multiple directions, so that the brightness of the light is reduced and the light extinction performance of the lens barrel is improved. Therefore, the surface blackness and light extinction performance of the lens assembly are improved through the microstructure disposed on the surface of the lens barrel, so as to improve the imaging quality. Compared with a coating process, the microstructure in some embodiments of the present disclosure has simple production steps and low cost.

It is apparent that the above-described embodiments are only part of the embodiments of the disclosure, not all of the embodiments. On the basis of the embodiments of the disclosure, all other embodiments obtained on the premise of no creative work of those of ordinary skill in the art should fall within the scope of protection of the disclosure.

It is to be noted that the terms used here are only used for describing the specific implementation modes, and are not intended to limit the exemplary implementation modes according to the present disclosure. As used herein, unless clearly specified otherwise in the context, the singular form is also intended to include the plural form. In addition, it should also be understood that when the terms “comprising” and/or “including” are used in the description, it is indicated that there are features, steps, operations, devices, components and/or combinations thereof.

It is to be noted that the terms “first”, “second”, and the like in the specification and claims of the present disclosure and in the above drawings are used to distinguish similar objects and are not necessarily used to describe a specific sequence or order. It will be appreciated that the data used in this way may be interchanged where appropriate, so that the implementation manners of the present disclosure described herein may be implemented in an order other than those illustrated or described herein.

The foregoing descriptions are some embodiments of the disclosure and are not intended to limit the disclosure. For those skilled in the art, the disclosure may have various changes and modifications. Any modifications, equivalent replacements and improvements made within the spirit and principle of the disclosure shall fall within the protection scope of the disclosure.

What is claimed is:

1. An optical imaging lens assembly, comprising:
a lens barrel having a body and a mount hole arranged on the body;
a lens disposed in the mount hole; and
a microstructure, wherein an outer wall surface of the body and/or an inner wall surface of the mount hole is provided with the microstructure.

2. The optical imaging lens assembly as claimed in claim 1, wherein when the outer wall surface of the body is provided with the microstructure, the body comprises an outer peripheral surface, a first end face, and a second end face opposite the first end face, and both the first end face and the second end face are connected with the outer peripheral surface,
wherein the first end face is provided with the microstructure; or
the second end face is provided with the microstructure; or
both the first end face and the second end face are provided with the microstructure respectively.

3. The optical imaging lens assembly as claimed in claim 1, wherein when the inner wall surface of the mount hole is provided with the microstructure, the microstructure is located in an area, which is not in contact with the lens, of the mount hole.

4. The optical imaging lens assembly as claimed in claim 1, wherein
when the microstructure is located on the outer wall surface of the body, the optical imaging lens assembly comprises a plurality of microstructures that are sequentially arranged around a center axis of the mount hole, from a center of the body to an outside of the body; or
when the microstructure is located on the inner wall surface of the mount hole, the optical imaging lens assembly comprises a plurality of microstructures that are sequentially arranged along an axial direction of the body.

5. The optical imaging lens assembly as claimed in claim 1, wherein the microstructure extends along a circumference of the mount hole to form a ring structure.

6. The optical imaging lens assembly as claimed in claim 1, wherein the microstructure comprises a convex rib or a spiral groove.

7. The optical imaging lens assembly as claimed in claim 6, wherein when the microstructure comprises the convex rib, a cross section of the convex rib is shaped as a triangle or a rectangle or a trapezoid.

8. The optical imaging lens assembly as claimed in claim 6, wherein when the microstructure comprises the convex rib, the optical imaging lens assembly comprises a plurality of microstructures, a groove is formed between every two adjacent microstructures in the plurality of microstructures, and the groove is a curved groove, a rectangular groove, or a triangular groove.

9. The optical imaging lens assembly as claimed in claim 1, wherein a height H of the microstructure satisfies a following condition: 0<H≤0.4 mm; or, an included angle B of the microstructure satisfies a following condition: 0<B<180; or when a plurality of microstructures are provided, an interval L between every two adjacent microstructures in the plurality of microstructures satisfies a following condition: 0<L≤0.2 mm.

10. A display device, comprising the optical imaging lens assembly as claimed in claim 1.

11. The display device as claimed in claim 10, wherein when the outer wall surface of the body is provided with the microstructure, the body comprises an outer peripheral surface, a first end face, and a second end face opposite the first end face, and both the first end face and the second end face are connected with the outer peripheral surface,
wherein the first end face is provided with the microstructure; or
the second end face is provided with the microstructure; or
both the first end face and the second end face are provided with the microstructure respectively.

12. The display device as claimed in claim 10, wherein when the inner wall surface of the mount hole is provided with the microstructure, the microstructure is located in an area, which is not in contact with the lens, of the mount hole.

13. The display device as claimed in claim 10, wherein when the microstructure is located on the outer wall surface of the body, the optical imaging lens assembly comprises a plurality of microstructures that are sequentially arranged around a center axis of the mount hole, from a center of the body to an outside of the body; or
when the microstructure is located on the inner wall surface of the mount hole, the optical imaging lens assembly comprises a plurality of microstructures that are sequentially arranged along an axial direction of the body.

14. The display device as claimed in claim 10, wherein the microstructure extends along a circumference of the mount hole to form a ring structure.

15. The display device as claimed in claim 10, wherein the microstructure comprises a convex rib or a spiral groove.

16. The display device as claimed in claim 15, wherein when the microstructure comprises the convex rib, a cross section of the convex rib is shaped as a triangle or a rectangle or a trapezoid.

17. The display device as claimed in claim 15, wherein when the microstructure comprises the convex rib, the optical imaging lens assembly comprises a plurality of microstructures, a groove is formed between every two adjacent microstructures in the plurality of microstructures, and the groove is a curved groove, a rectangular groove, or a triangular groove.

18. The display device as claimed in claim 10, wherein a height H of the microstructure satisfies a following condition: 0<H≤0.4 mm; or, an included angle B of the microstructure satisfies a following condition: 0<B<180; or when a plurality of microstructures are provided, an interval L between every two adjacent microstructures in the plurality of microstructures satisfies a following condition: 0<L≤0.2 mm.
